(19) United States
(12) Patent Application Publication
(10) Pub. No.: US 2010/0150000 A1
(43) Pub. Date: Jun. 17, 2010

(54) RADIO COMMUNICATION SYSTEM, BASE STATION, TERMINAL APPARATUS AND PILOT SIGNAL CONTROLLING METHOD

(75) Inventor: Ren Sakata, Kanagawa-Ken (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: KABUSHIKI KAISHA TOSHIBA, Minato-ku (JP)

(21) Appl. No.: 11/816,024

(22) PCT Filed: Jul. 11, 2007
(86) PCT No.: PCT/JP2007/064131

§ 371 Date: Feb. 13, 2008

(30) Foreign Application Priority Data
Jul. 27, 2006 (JP) 2006-204938

(51) Int. Cl. H04W 24/00; H04W 52/04

(52) U.S. Cl. 370/252; 370/329

(57) ABSTRACT

There is provided with a radio communication system in which a base station using a multicarrier transmission scheme as a transmission scheme and a terminal apparatus are wirelessly connected, wherein the base station includes: a data generator configured to generate first pilot signals for the terminal apparatus to measure channel quality, second pilot signals for the terminal apparatus to estimate a channel and data signals to be transmitted to the terminal apparatus; a transmission power controller configured to control transmission power of the second pilot signals and the data signals by adjusting amplitude of the second pilot signals and the data signals respectively; and a transmitter configured to generate subcarrier data by mapping the first pilot signals, the second pilot signals power-controlled by the transmission power controller and the data signals power-controlled by the transmission power controller to a plurality of subcarriers and transmit the subcarrier data generated.

### BACKGROUND OF THE INVENTION

1. Field of the Invention

The present invention relates to a radio communication system, a base station, a terminal apparatus and a pilot signal controlling method, and more particularly, to a multicarrier communication system.

2. Related Art

Techniques such as OFDM communication and multicarrier CDMA communication, for mapping digital signals to a plurality of subcarriers and transmitting and receiving the signals spread over a wideband to thereby enhance the transmission speed and improve resistance to frequency selective fading are becoming a focus of attention in recent years. Furthermore, OFDMA which provides subbands resulting from grouping a plurality of subcarriers and realizes a plurality of simultaneous communications is also known.

As for OFDMA communication, there is also a known means which takes advantage of the fact that channels with a plurality of other communication destinations have different frequency characteristics and applies allocation selectively using subbands of good communication quality to each communication party to thereby improve the communication speed. Realizing this allocation requires the frequency characteristic of each channel to be obtained for each subband. JP-A 2005-244958 (Kokai) describes a method whereby in a communication from a base station to a terminal, the terminal measures channel conditions of subbands and feeds back quality information (CQI: Channel Quality Indicator) of subbands of good communication quality to the base station. When measuring communication quality of the subbands, the base station transmits a signal for measurement to the terminal. Hereinafter, this signal for measurement will be referred to as a “first pilot signal.”

Since the first pilot signal uses a signal defined for the system beforehand, it can be used not only to measure communication quality but also to calculate amplitude and a phase reference during data demodulation by the terminal. That is, the terminal stores the first pilot signal transmitted from the base station beforehand and can estimate transmission distortion such as an amplitude variation and phase rotation by comparing it with the first pilot signal received with distortion caused by transmission through a radio communication path. Since a data signal is also affected by similar distortion, it is possible to demodulate the data signal with reference to the amplitude and the phase obtained from the first pilot signal.

Next, transmission power control (TPC) will be described. In order to effectively use limited frequency resources in a radio communication, an identical frequency may be reused in geographically distant places or may be subjected to code division multiplexing (CDM), time division multiplexing (TDM) or space division multiplexing (SDM). When such reuse or multiplexing is realized, signals may interfere with each other as the nature of those schemes or due to the incompleteness of control. For example, in CDMA (Code Division Multiple Access) which uses CDM for user multiplexing, not only delay waves may produce interference but also complete orthogonality may not be guaranteed between spreading codes depending on circumstances. In such an environment, power during transmission is preferably suppressed to a minimum to confine interference with the other destination within a minimal range. This control is called “TPC.” An example of applying TPC to OFDM is described in JP-A 2005-123898 (Kokai).

However, applying TPC to a radio communication system which conducts CQI measurement may cause a problem. When TPC is applied to a signal for measuring radio channel quality, that is, a first pilot signal, a receiver cannot distinguish whether a change in the received signal is caused by a change in a channel condition or TPC. Therefore, even when performing TPC on the entire signal including user data, applying TPC to a first pilot signal is not desirable. In this case, the transmission power of the first pilot signal differs from that of the data signal, preventing the terminal from using the amplitude obtained from the first pilot signal as the reference for demodulation. Therefore, JP-A 2005-123898 (Kokai) proposes a radio signal composed of, in addition to a pilot signal not subjected to TPC for measuring radio channel quality, that is, the first pilot signal, control data which can be demodulated using only the first pilot signal, further a pilot signal subjected to TPC, that is, a second pilot signal and user data. This configuration makes it possible to generate CQI using the first pilot signal not subjected to TPC and further generate an amplitude reference for demodulation using the second pilot signal.

A conventional radio communication system, a radio communication system which performs transmission power control and realizes both communication quality measurement and channel estimation in particular, cannot perform transmission power control over a signal for communication quality measurement, and therefore requires both a reference signal transmitted with fixed power and a reference signal subjected to transmission power control for channel estimation. Separating a signal for communication quality measurement and a signal for channel estimation which are same signal in a system not conducting transmission power control and transmitting both signals separately in a system conducting transmission power control leads to consumption of communication resources and produces wastage. This results in a problem that the amount of data that can be sent decreases and the throughput degrades.

### SUMMARY OF THE INVENTION

According to an aspect of the present invention, there is provided with a radio communication system in which a base station using a multicarrier transmission scheme as a transmission scheme and a terminal apparatus are wirelessly connected,

wherein the base station comprises:

a data generator configured to generate first pilot signals for the terminal apparatus to measure channel quality, second pilot signals for the terminal apparatus to estimate a channel and data signals to be transmitted to the terminal apparatus;

a transmission power controller configured to control transmission power of the second pilot signals and the data signals by adjusting amplitude of the second pilot signals and the data signals respectively; and

a transmitter configured to generate subcarrier data by mapping the first pilot signals, the second pilot signals power-controlled by the transmission power controller and the data signals power-controlled by the transmission power controller to a plurality of subcarriers and transmit the subcarrier data generated.

According to an aspect of the present invention, there is provided with a radio communication system in which a base station using a multicarrier transmission scheme as a transmission scheme and a terminal apparatus each having a plurality of transmission antennas are wirelessly connected,

wherein the base station comprises:

a data generator configured to generate first pilot signals for the terminal apparatus to measure channel quality, second pilot signals for the terminal apparatus to estimate a channel and data signals to be transmitted to the terminal apparatus and divide the data signals into portions corresponding in number to the plurality of transmission antennas;

a transmission power controller configured to control transmission power of the second pilot signals and each divided data signals by adjusting the amplitude of the second pilot signals and each divided data signals respectively; and

a plurality of transmitters provided in correspondence with the respective transmission antennas configured to map the first or second pilot signals and the divided data signals to a plurality of subcarriers to generate subcarrier data in such a way that the first and second pilot signals are each transmitted from at least one of the transmission antennas and transmit generated subcarrier data from the respective transmission antennas.

According to an aspect of the present invention, there is provided with a base station which is wirelessly connected to a terminal apparatus and uses a multicarrier transmission scheme as a transmission scheme, comprising:

a data generator configured to generate first pilot signals for the terminal apparatus to measure channel quality, second pilot signals for the terminal apparatus to estimate a channel and data signals to be transmitted to the terminal apparatus;

a transmission power controller configured to control transmission power of the second pilot signals and the data signals by adjusting amplitude of the second pilot signals and the data signals respectively; and

a transmitter configured to generate subcarrier data by mapping the first pilot signals, the second pilot signals power-controlled by the transmission power controller and the data signals power-controlled by the transmission power controller to a plurality of subcarriers and transmit the subcarrier data generated.

According to an aspect of the present invention, there is provided with a terminal apparatus wirelessly connected to a base station using a multicarrier transmission scheme as a transmission scheme, comprising:

a receiver configured to perform a Fourier transform on received signals obtained by an antenna and thereby acquire first pilot signals for measuring channel quality and second pilot signals for estimating a channel and data signals;

an amplitude measuring unit configured to measure amplitude of the second pilot signals;

an amplitude adjuster configured to adjust the amplitude of the first pilot signals to same amplitude as that of the second pilot signals;

a channel estimator configured to estimate a channel using the first pilot signals whose amplitude is adjusted and the second pilot signals and thereby acquire a channel estimated value indicating a state of the channel; and

a demodulator configured to demodulate the data signals using the channel estimated value.

According to an aspect of the present invention, there is provided with a base station having a plurality of transmission antennas which is wirelessly connected to a terminal apparatus and uses a multicarrier transmission scheme as a transmission scheme, comprising:

a data generator configured to generate first pilot signals for the terminal apparatus to measure channel quality, second pilot signals for the terminal apparatus to estimate a channel and data signals to be transmitted to the terminal apparatus and divide the data signals into portions corresponding in number to the plurality of transmission antennas;

a transmission power controller configured to control transmission power of the second pilot signals and each divided data signals by adjusting the amplitude of the second pilot signals and each divided data signals respectively; and

a plurality of transmitters provided in correspondence with the respective transmission antennas configured to map the first or second pilot signals and the divided data signals to a plurality of subcarriers to generate subcarrier data in such a way that the first and second pilot signals are each transmitted from at least one of the transmission antennas and transmit generated subcarrier data from the respective transmission antennas.

According to an aspect of the present invention, there is provided with a pilot signal controlling method of a radio communication system in which a base station using a multicarrier transmission scheme as a transmission scheme and a terminal apparatus are wirelessly connected, comprising:

generating by the base station first pilot signals for the terminal apparatus to measure channel quality, second pilot signals for the terminal apparatus to estimate a channel and data signals to be transmitted to the terminal apparatus;

controlling by the base station transmission power of the second pilot signals and the data signals by adjusting amplitude of the second pilot signals and the data signals respectively; and

generating by the base station subcarrier data by mapping the first pilot signals, the second pilot signals power-controlled and the data signals power-controlled to a plurality of subcarriers and transmitting by the base station the subcarrier data generated.

### BRIEF DESCRIPTION OF THE DRAWINGS

FIG. 1 is a schematic view showing the system configuration of an embodiment of a radio communication system according to the present invention;

FIG. 2 is a schematic view showing an embodiment of a transmission scheme according to the present invention;

FIG. 3 is a schematic view showing the frame configuration of a first embodiment;

FIG. 4 is a schematic view showing an embodiment of the frame configuration according to a comparative example;

FIG. 5 is a schematic view showing an embodiment of subcarrier arrangement in the first embodiment;

FIG. 6 is a block diagram showing an outline of the base station configuration in the first embodiment;

FIG. 7 is a schematic view showing an outline of information fed back from the terminal to the base station in the first embodiment;

FIG. 8 is a block diagram showing an outline of the terminal configuration in the first embodiment;

FIG. 9 is a block diagram showing an outline of the base station configuration in a second embodiment;

FIG. 10 is a schematic view showing an outline of information fed back from the terminal to the base station in the second embodiment;

FIG. 11 is a block diagram showing an outline of the terminal configuration in the second embodiment;

FIG. 12 is a schematic view showing an embodiment of subcarrier arrangement in the second embodiment;

FIG. 13 is a flow chart showing an outline of pilot signal control by the base station in the second embodiment;

FIG. 14 is a flow chart showing an outline of another mode of pilot signal control by the base station in the second embodiment;

FIG. 15 is a block diagram showing an outline of the base station configuration in a third embodiment;

FIG. 16 is a schematic view showing an embodiment of the frame configuration in the third embodiment; and

FIG. 17 is a block diagram showing an outline of the terminal configuration in the third embodiment.

### DETAILED DESCRIPTION OF THE INVENTION

Hereinafter, embodiments will be explained in detail with reference to the attached drawings.

### (1) First Embodiment

### Overview

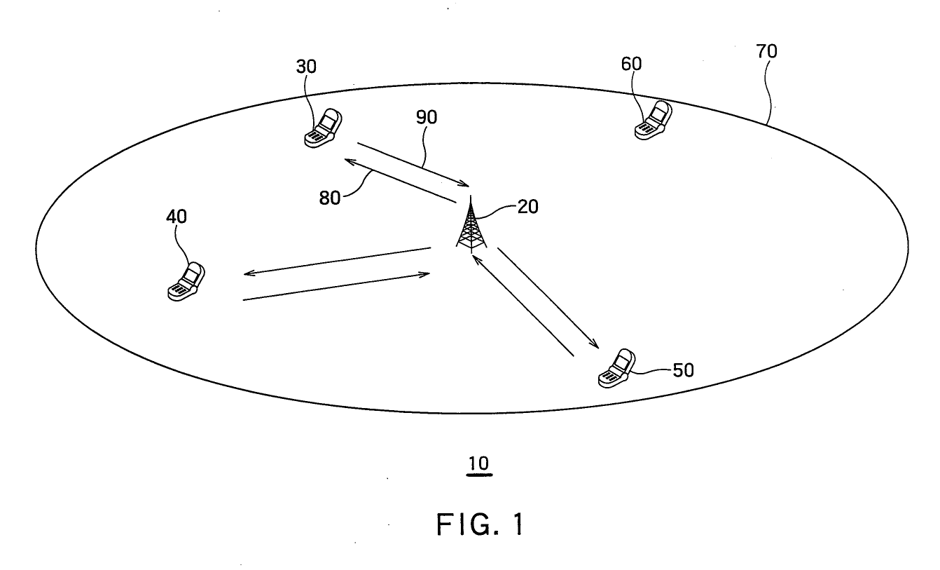

FIG. 1 shows a radio communication system 10 according to an embodiment of the present invention. The radio communication system 10 according to this embodiment includes a base station 20 and terminals 30 to 60. Suppose the radio communication system 10 is constructed, for example, of four terminals 30 to 60 and the terminal 30, terminal 40, terminal 50 and terminal 60 are located within reach of radio signals from the base station 20, that is, a cell 70. Suppose radio signal transmission from the base station 20 to each of the terminals 30 to 60 is referred to as a downlink 80 and on the contrary radio signal transmission from each of the terminals 30 to 60 to the base station 20 is referred to as an uplink 90.

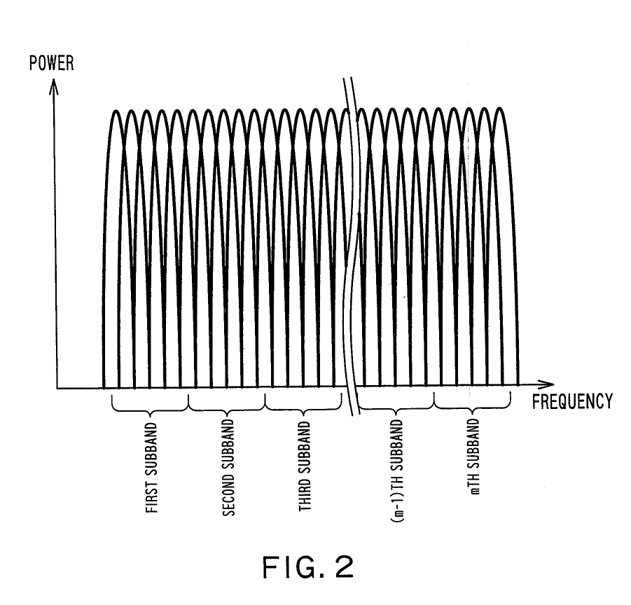

Furthermore, the downlink is frequency division multiplexed as shown in FIG. 2, with subbands composed of a single or a plurality of subcarriers formed and a plurality of terminals, users or channels assigned to the subbands.

### (Method of Arranging Signals on Subcarrier)

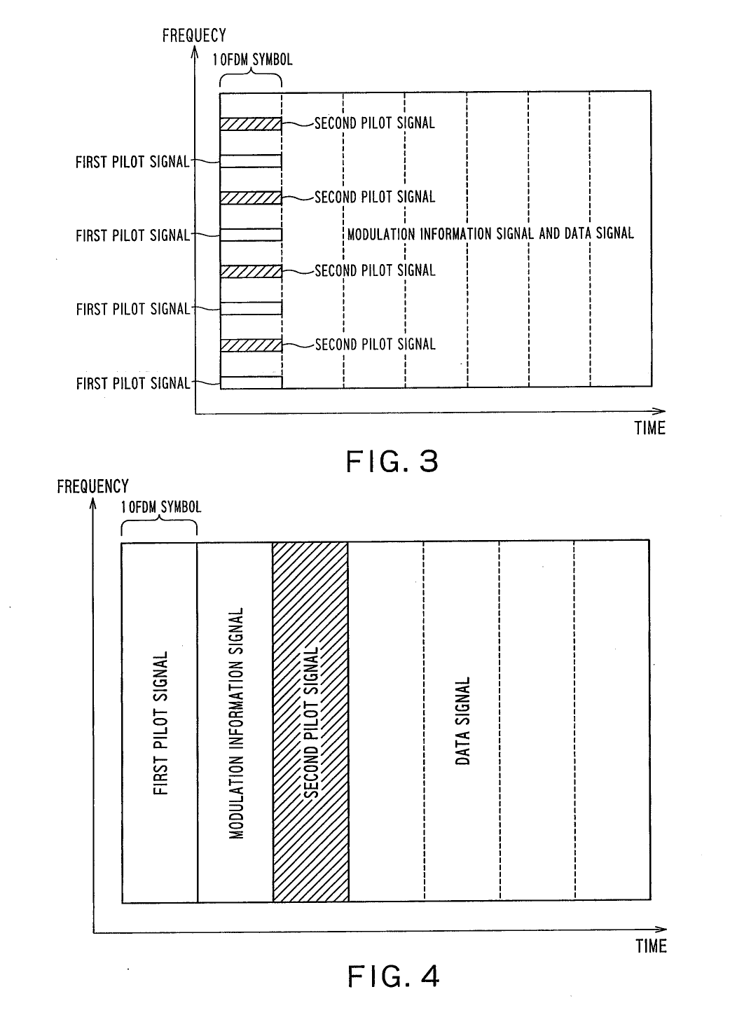

First, the method of arranging pilot subcarriers in this embodiment will be explained in detail with reference to FIG. 3 to FIG. 5. In this embodiment, as shown in FIG. 3, first pilot signals to be used for channel quality measurement and second pilot signals to be used for channel estimation are arranged within 1 OFDM symbol.

Suppose a subcarrier on which a first pilot signal is arranged is called a “first pilot subcarrier” and is transmitted with fixed power from the base station. Furthermore, suppose that first pilot subcarriers are uniformly arranged over a signal band transmitted to obtain correct channel quality of each subband.

In the same way, suppose a subcarrier on which a second pilot signal is transmitted is called a “second pilot subcarrier” and is arranged between neighboring first pilot subcarriers. Furthermore, suppose a subcarrier on which a first pilot subcarrier or a second pilot subcarrier is arranged is called a “pilot subcarrier.”

The method in FIG. 4 shown as a comparative example consumes temporal resources redundantly to transmit first pilot signals and second pilot signals. For example, if transmission of each pilot signal is supposed to require 1 OFDM symbol, transmission of both pilot signals requires 2 OFDM symbols. For example, when all signals together should be confined within 7 OFDM symbols to be transmitted, pilot signals accounts for as large as approximately 29% and only 71% of communication resources are available for data signals, which is quite inefficient.

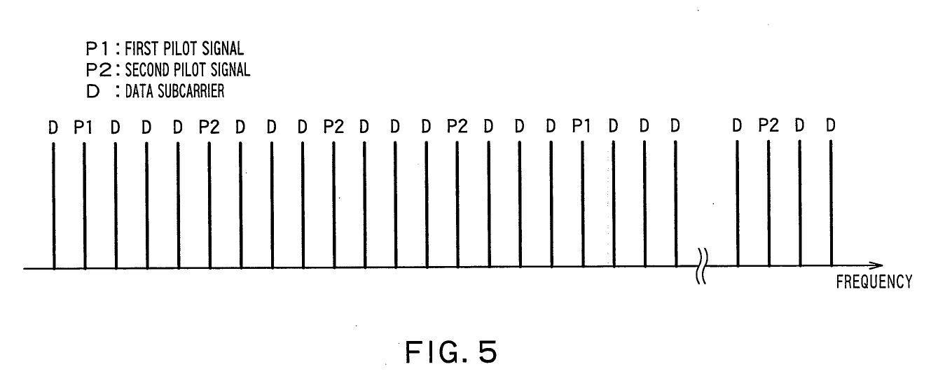

Here, FIG. 5 shows an example of a more detailed configuration of an OFDM symbol including first pilot subcarriers and second pilot subcarriers. In FIG. 5, there is a distance of 16 subcarriers between first pilot subcarriers and three second pilot subcarriers are inserted therebetween. Pilot subcarriers are arranged at intervals of 4 subcarriers and the pilot subcarrier of the lowest frequency is arranged on the second subcarrier counted from the lowest frequency side. Furthermore, suppose data subcarriers to send and receive data signals are arranged between pilot subcarriers.

When subcarriers are defined as subcarrier number 1, subcarrier number 2, . . . , in ascending order of frequency and the above described arrangement is expressed by a general expression, subcarriers on which first pilot subcarriers are arranged are expressed by the following subcarrier numbers first.

MNₖ+M_{b}(k=1, 2, . . . (L−M_{b})/MN) [Equation 1]

Here, suppose the total number of subcarriers is L, the subcarrier interval of pilot subcarriers is M, the position of the pilot subcarrier of the lowest frequency is M_{b} and the number of second pilot signals located between neighboring first pilot signals is N−1. The interval of first pilot signals is MN subcarriers and first pilot signals are arranged uniformly within a band. In the example of FIG. 5, M_{b}=2, M=4, N=4.

The number of a subcarrier on which a second pilot signal is arranged is expressed by the following expression.

Mk+M_{b}(k=1, 2, . . . (L−M_{b})/M, k≠NMI(I=1=1, 2, . . . , (L−M_{b})/MN)) [Equation 2]

The above described arrangement of first pilot signals and second pilot signals allows pilot signals to be arranged uniformly within the frequency band used by the radio communication system 10.

The above described configuration allows an OFDM symbol occupied by pilot signals to be limited to 1 symbol and when the number of OFDM symbols that can be transmitted is 7, even if there is no data subcarrier between pilot subcarriers, the amount occupied by pilot signals can be reduced to approximately 14%. It is thereby possible to secure 86% as the amount occupied by data signals and improve the efficiency as much as approximately 21% compared to the comparative example. When data subcarriers are arranged between pilot subcarriers, the data transmission efficiency further improves.

### (Configuration of Base Station)

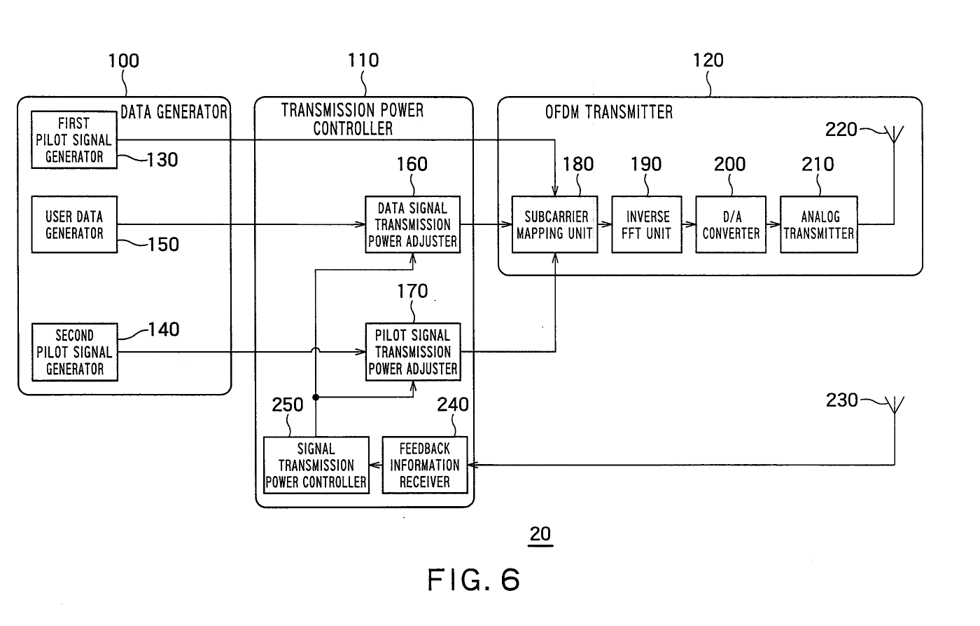

FIG. 6 shows the apparatus configuration of the base station 20 in the radio communication system 10 according to this embodiment. This base station 20 is constructed of a first pilot signal generator 130, a second pilot signal generator 140, a user data generator 150, a data signal transmission power adjuster 160, a pilot signal transmission power adjuster 170, a subcarrier mapping unit 180, an inverse FFT unit 190, a D/A converter 200, a analog transmitter 210, a base station transmission antenna 220, a base station reception antenna 230, a feedback information receiver 240 and a signal transmission power controller 250.

The first pilot signal generator 130, second pilot signal generator 140 and user data generator 150 form a data generator 100, the data signal transmission power adjuster 160, pilot signal transmission power adjuster 170, feedback information receiver 240 and signal transmission power controller 250 form a transmission power controller 110, and the subcarrier mapping unit 180, inverse FFT unit 190, D/A converter 200, analog transmitter 210 and base station transmission antenna 220 form an OFDM transmitter 120.

The first pilot signal generator 130 generates reference signals for the terminals 30 to 60 to measure channel quality. Suppose these reference signals used for channel quality measurement are called “first pilot signals.” The first pilot signals must be the signals arranged beforehand between the base station 20 and terminals 30 to 60 before starting a communication. That is, they must be known signals.

The second pilot signal generator 140 generates reference signals for the terminals 30 to 60 to use for channel estimation. Suppose these reference signals used for channel estimation are called “second pilot signals.” The second pilot signals also must be the signal arranged beforehand between the base station 20 and terminals 30 to 60 before starting a communication. That is, they must be known signals. The sequence of second pilot signals may be the same as the sequence of first pilot signals or may be different.

The user data generator 150 plays a role of converting an information sequence sent from an application (not shown) to a bit sequence to be transmitted through a radio signal. Furthermore, suppose control signals sent from the base station 20 to the terminals 30 to 60 are also generated at the user data generator 150. Suppose the bit sequence generated by the user data generator 150 is called “user data.” That is, this user data also includes control information as well as information sent from the application.

The data signal transmission power adjuster 160 controls transmission power of the user data inputted from the user data generator 150 based on control information from the signal transmission power controller 250, which will be described later. That is, the data signal transmission power adjuster 160 controls the amplitude of the user data. A coefficient by which the amplitude of the user data inputted at this time is multiplied is given from the signal transmission power controller 250.

The pilot signal transmission power adjuster 170 controls the amplitude of the second pilot signal given from the second pilot signal generator 140 based on control information of the signal transmission power control 250, which will be described later. A coefficient by which the amplitude of the second pilot signal inputted at this time is multiplied is given from the signal transmission power controller 250.

The subcarrier mapping unit 180 arranges the first pilot signals, second pilot signal and user data on their respective subcarriers when carrying out OFDM communication. More specifically, the subcarrier mapping unit 180 arranges the first pilot signals on first pilot subcarriers, the second pilot signals on second pilot subcarriers and user data on data subcarriers. Assuming that the total number of subcarriers is L, the interval at which any one of the first pilot signal and the second pilot signal is arranged is M and the number of the second pilots arranged between the neighboring first pilots is N−1, the contents of a signal arranged on each pilot are expressed by the expression described below.

The number of a subcarrier on which a pilot signal of any one of the first pilot subcarrier and the second pilot subcarrier is arranged is expressed by the following expression.

Mk+M_{b}(k=1, 2, . . . (L−M_{b})/M, k≠NMI(I=1, 2, . . . , (L−M_{b}/MN)) [Equation 3]

Furthermore, the number of a subcarrier on which the first pilot subcarrier is arranged is expressed by the following expression.

MNk+M_{b}(k1, 2, . . . (L−M_{b})/MN) [Equation 4]

M_{b} shows a rightward or leftward shift of the position of a pilot signal and is defined as the number of subcarriers arranged from the subcarrier of the lowest frequency to the subcarrier on which the first pilot signal or the second pilot signal of the lowest frequency. User data are arranged on subcarriers other than these subcarriers. This embodiment assumes that L, M and N are predefined values.

The first pilot signals, second pilot signals or user data are modulated when they are arranged on subcarriers by the subcarrier mapping unit 180. As the modulation scheme, for example, BPSK, QPSK, ASK, 64QAM or the like can be used. If BPSK modulation is performed, 1 bit is allocated to one subcarrier. On the other hand, if QPSK is used, 2 bits are allocated to 1 subcarrier. If 64QAM is used, 6 bits are allocated to 1 subcarrier.

The inverse FFT unit 190 applies inverse FFT processing to the modulated signal of each subcarrier inputted from the subcarrier mapping unit 180. In this case, a baseband time waveform for carrying out an OFDM communication is generated. This baseband time waveform is converted to an analog signal by the D/A converter 200, then inputted to the analog transmitter 210, converted to a signal of a radio frequency and transmitted from the base station transmission antenna 220.

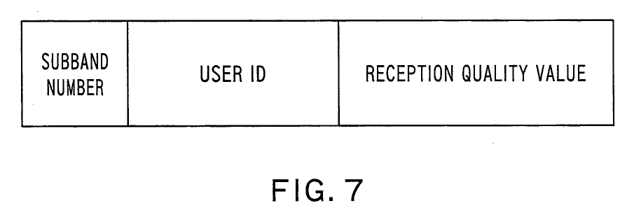

The base station reception antenna 230 receives signals transmitted from the terminals 30 to 60. The received signals are sent to the feedback information receiver 240. The feedback information receiver 240 extracts information fed back to the base station 20 from the terminals 30 to 60 included in the received signals. To extract the information, in general the received radio signal is converted to a baseband signal, further converted to a digital signal and then subjected to demodulation processing. Suppose such processing is included in the feedback information receiver 240. Suppose the information fed back from the terminals 30 to 60 to the base station 20 is information on transmission power control in this embodiment. That is, suppose such information is a request to increase or a request to decrease transmission power sent from the terminals 30 to 60 to the base station 20. These requests may be made not explicitly and, for example, a method can be considered whereby the terminals 30 to 60 feed back their current channel quality information. According to this method, the base station 20 judges whether transmission power should be increased or decreased using the fed back channel quality information. As the channel quality information, for example, reception power at the terminals 30 to 60, the modulation scheme and error correction coding rate whereby reception with the reception power is possible or index numbers indicating them or the current error rate can be used. An example of the channel quality information is shown in FIG. 7.

Using the channel quality information fed back from the respective terminals 30 to 60, the signal transmission power controller 250 judges whether to increase or decrease transmission power. Since this embodiment assumes a system in which a plurality of subbands are allocated to a plurality of users, transmission power of each subband is controlled here. When reception power at the terminals 30 to 60 is judged to be too low or a high incidence of errors is estimated at a subband, transmission power is increased. On the contrary, when transmission power can be judged to be too high or a low incidence of errors is estimated, transmission power is decreased. This processing allows transmission power of a minimum limit necessary for the terminals 30 to 60 to receive information to be set, and as a result it is possible to decrease the amount of interference with other receivers or other systems. An instruction for increasing or decreasing the transmission power obtained as a result of such judgments, that is, a transmission power control instruction is given to the data signal transmission power adjuster 160 and the pilot signal transmission power adjuster 170.

### (Configuration of Terminal)

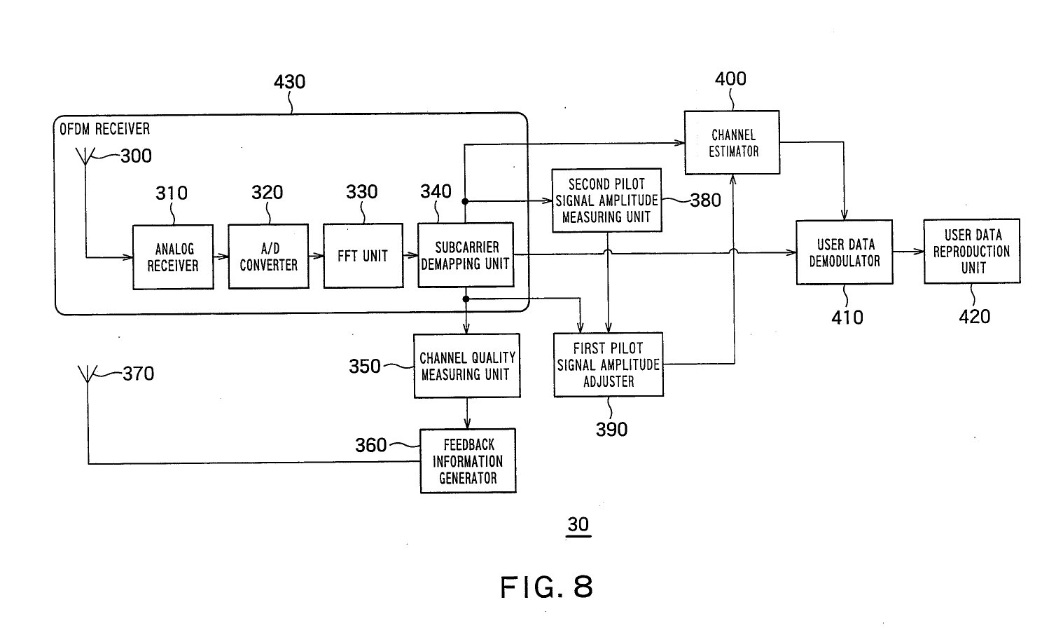

FIG. 8 shows the apparatus configuration of the terminal 30 in the radio communication system 10 according to this embodiment. This terminal 30 is constructed of a terminal reception antenna 300, a analog receiver 310, an A/D converter 320, an FFT unit 330, a subcarrier demapping unit 340, a channel quality measuring unit 350, a feedback information generator 360, a terminal transmission antenna 370, a second pilot signal amplitude measuring unit 380, a first pilot signal amplitude adjuster 390, a channel estimator 400, a user data demodulator 410 and a user data reproduction unit 420.

The terminal reception antenna 300, analog receiver 310, A/D converter 320, FFT unit 330 and subcarrier demapping unit 340 form an OFDM receiver 430.

A downlink signal transmitted from the base station 20 is received by the terminal reception antenna 300. The received signal is converted to a reception baseband signal by the analog receiver 310. The signal is then converted to a digital signal by the A/D converter 320 and inputted to the FFT unit 330. The FFT unit 330 converts the received baseband signal to a spectrum and extracts a signal superimposed on each subcarrier. This extracted signal is inputted to the subcarrier demapping unit 340.

Of the signals obtained from the respective subcarriers, the subcarrier demapping unit 340 extracts first pilot signals from first pilot subcarriers, second pilot signals from second pilot subcarriers and user data from data subcarriers. These are actually classified by referring to the number of each subcarrier. A first pilot signal or a second pilot signal, that is, a pilot signal can be extracted from a subcarrier with a subcarrier number which is expressed by the following expression.

Mk+M_{b}(k=1, 2, . . . (L−M_{b})/M) [Equation 5]

Furthermore, of the pilot signals obtained according to the above described expression, a pilot signal mapped to a subcarrier expressed by the following expression is a first pilot signal.

MNk+M_{b}(k=1, 2, . . . (L−M_{b})/MN) [Equation 6]

Pilot signals other than these signals are second pilot signals. Furthermore, user data are extracted from subcarriers on which no pilot signal is mapped. The extracted first pilot signals are sent to the channel quality measuring unit 350, which will be described later, the second pilot signals are sent to the channel estimator 400 and the user data are sent to the user data demodulator 410.

The first pilot signals extracted by the subcarrier demapping unit 340 are inputted to the channel quality measuring unit 350. The channel quality measuring unit 350 measures channel quality by measuring the reception power of the first pilot signals. The first pilot signals are transmitted with fixed power from the base station 20, but received with lower power by being attenuated after passing through the channel. Therefore, the channel quality can be expressed by the reception power. However, the channel quality need not always be decided by the reception power, and when, for example, the propagation path is a multipath propagation path, the channel may also deteriorate due to delay waves. Therefore, it is also possible to estimate channel distortion due to multipath from the spectrum of the first pilot signal and assume the degree of this distortion as channel quality. The channel quality determined at the channel quality measuring unit 350 is sent to the feedback information generator 360.

The feedback information generator 360 generates information to be fed back to the base station 20 based on the channel quality information obtained from the channel quality measuring unit 350. The information to be fed back may be reception power itself as described above or may be a modulation scheme and error correction coding rate whereby reception with the current reception power is possible. This channel quality information is described in the field of the reception quality value shown in FIG. 7.

The feedback information generated at the feedback information generator 360 is further converted to an analog signal, converted to a radio frequency and then transmitted from the terminal transmission antenna 370.

At the same time, the first pilot signal extracted from the subcarrier demapping unit 340 is sent to the first pilot signal amplitude adjuster 390. Since transmission power of the first pilot signal is not controlled, it is not possible to demodulate a data signal subjected to transmission power control using this first pilot signal. However, since transmission power of the second pilot signal is controlled at the time of transmission, if the amplitude is adjusted so as to be the same amplitude of the second pilot signal, the second pilot signal can be used to demodulate a data signal. The first pilot signal amplitude adjuster 390 performs this amplitude adjustment processing. Such adjustment requires the amplitude value of the second pilot signal and this is given from the second pilot signal amplitude measuring unit 380. The second pilot signal amplitude measuring unit 380 measures the amplitude of the second pilot signal obtained from the subcarrier demapping unit 340 and outputs it to the first pilot signal amplitude adjuster 390. The first pilot signal amplitude adjuster 390 makes an adjustment by multiplying the first pilot signal by the ratio of the second pilot signal amplitude to the first pilot signal amplitude. Suppose, for example, average amplitudes of all first pilot signals and second pilot signals are used as the first pilot signal amplitude and the second pilot signal amplitude.

Aforementioned JP-A 2005-123898 (Kokai) describes a method of determining a vector sum of a first pilot signal and a second pilot signal arranged with the same subcarrier number, thereby determining a new phase reference and demodulating a data signal. JP-A 2005-123898 (Kokai) assumes that both pilot signals are transmitted at two mutually proximate times and since the variation of the channel due to this time difference is minimal, the phases of both subcarriers can be assumed to be substantially the same and therefore such a vector sum can be used. However, since the first pilot signal and the second pilot signal are never arranged with the same subcarrier number in this embodiment, it is not possible to assume that they can be considered to have the same phase, hence the vector sum cannot be used. However, adjusting the amplitude in the above described way allows a data signal to be demodulated using both first pilots and second pilots.

On the other hand, since user data is affected by distortion due to multipath in radio transmission, it has a shape different from that of the transmitted signal. Therefore, a signal for correcting this distortion, that is, a channel estimated value is obtained at the channel estimator 400. When the channel estimator 400 determines a channel estimated value, it uses the first pilot signal after amplitude adjustment obtained from the first pilot signal amplitude adjuster 390 and the second pilot signal obtained from the subcarrier demapping unit 340. Each received pilot signal is compared with the first pilot signal and the second pilot signal transmitted after being prearranged and an amplitude variation and phase rotation produced in the channel are estimated. Since similar phase rotation is also superimposed on the user data, it is possible to determine the amount of phase rotation to be corrected when demodulating the user data. The amplitude reference and the phase reference determined in this way are sent to the user data demodulator 410 as the channel estimated value.

The user data demodulator 410 demodulates the user data using the channel estimated value obtained from the channel estimator 400 and the user data obtained from the subcarrier demapping unit 340. As described above, the user data extracted from the subcarrier demapping unit 340 is affected by a variation of the amplitude and phase rotation after passing through the channel. Furthermore, the variation of amplitude and phase rotation are expressed in the channel estimated value determined at the channel estimator 400. Therefore, the transmitted user data can be obtained by multiplying the user data by an inverse characteristic of the channel estimated value. The user data demodulator 410 further demodulates signals modulated based on the modulation scheme such as BPSK, QPSK, ASK or 64QAM at the same time. Therefore, a bit sequence is outputted from the user data demodulator 410 and inputted to the user data reproduction unit 420. The user data reproduction unit 420 extracts information for the terminal from the extracted bit sequence.

### (Effects)

Simultaneously transmitting the first and second pilot signals can increase the amount of transmission of the data signal compared to the case where the signals are transmitted at different times.

Furthermore, uniformly arranging the pilot signals which are used to create demodulation references and subjected to transmission power control and the fixed power pilot signals which are used to measure channel quality within a band used can make measurement accuracy uniform. Preventing locations with low measurement accuracy from being created reduces locations with poor error rates and realizes uniform communications among users.

### (2) Second Embodiment

### Overview

Next, a second embodiment will be explained. The second embodiment will consider changing the density of first pilot signals and the density of second pilot signals. Since received first pilot signals are corrected with a measured value of the amplitude of received second pilot signals, accuracy as a demodulation reference is slightly inferior. On the other hand, when many second pilot signals are arranged on many second pilot subcarriers, many high accuracy demodulation references can be obtained and improvement of the reception performance can thereby be expected. Moreover, the presence of many first pilot signals which must be transmitted with always constant high power may lead to an increase of transmission power from the base station or a relative reduction of transmission power of the second pilot signals and data signals. Furthermore, the first pilot signals are used for communication quality measurement but the first pilot signals need not be sent excessively as long as they fall within a range in which the desired measurement accuracy can be obtained. Therefore, this embodiment considers such control that dynamically increases second pilot signals with the aim of improving reception performance with the help of the feedback information from the terminal and further dynamically decreases excessive first pilot signals.

### (Configuration of Base Station)

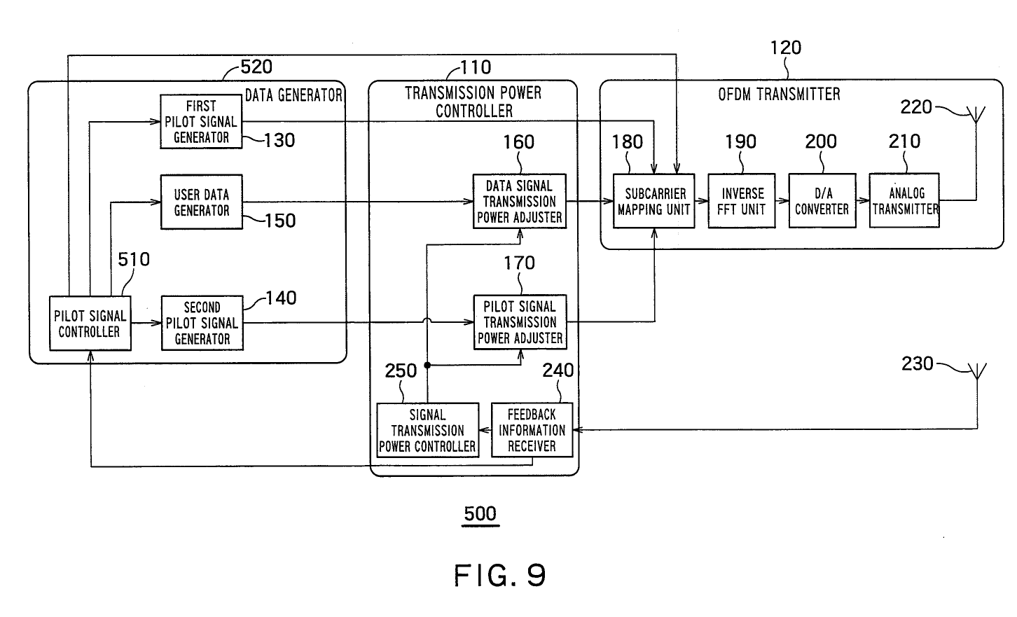

FIG. 9 shows the configuration of a base station 500 used in the second embodiment. A big difference from the base station 20 in the first embodiment shown in FIG. 6 is that a pilot signal controller 510 is added and a feedback information receiver 240, first pilot signal generator 130, second pilot signal generator 140, user data generator 150 and subcarrier mapping unit 180 are connected to the pilot signal controller 510.

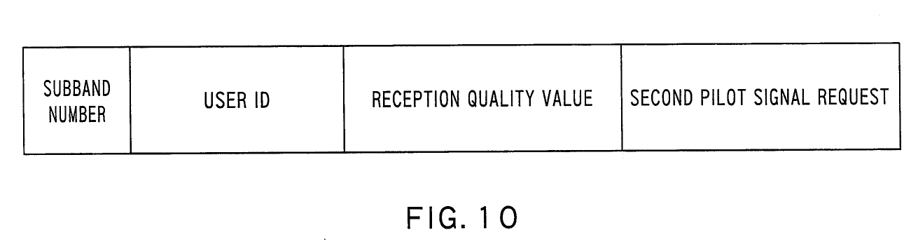

The feedback information receiver 240 extracts a request signal of a second pilot signal from feedback information sent from the terminal in addition to the operation of the first embodiment. Suppose this request signal is included in channel quality information and fed back from a terminal as shown in FIG. 10 and when, for example, an increase of the amount of second pilot signals is requested, “1” is described and when a decrease is requested, “0” is described. A specific amount of increase/decrease may also be described. A plurality of second pilot signal requests fed back from a plurality of terminals are extracted by the feedback information receiver 240 and then inputted to the pilot signal controller 510.

The pilot signal controller 510 controls the amount of first pilots and second pilots included in the next transmission based on the plurality of second pilot signal requests sent from each terminal. In other words, this is equivalent to changing the value of N in the first embodiment. As an example in this embodiment, suppose N is limited to a power of 2 equal to or greater than 2. Then, the second subcarrier is always located on the (2Mk+M_{b}(k=0, 1, . . . (L−M_{b})/2M))th subcarrier. Then, the terminal can extract second pilot signals from (L−M_{b})/2M subcarriers even when N is unknown.

The determined N is sent to the first pilot signal generator 130, second pilot signal generator 140 and subcarrier mapping unit 180. The first pilot signal generator 130 generates first pilot signals to be mapped to (L−M_{b})/MN subcarriers. Furthermore, the second pilot signal generator 140 generates second pilot signals to be mapped to ((L−M_{b})/M−(L−M_{b})/MN) subcarriers. The subcarrier mapping unit 180 arranges first pilot signals and second pilot signals according to the method explained in the first embodiment.

“N” determined by the pilot signal controller 510 is also sent to the user data generator 150. The user data generator 150 also performs an operation of describing N in a control signal in addition to the operation of the first embodiment.

Suppose the operations of other blocks are the same as those in the first embodiment.

### (Configuration of Terminal)

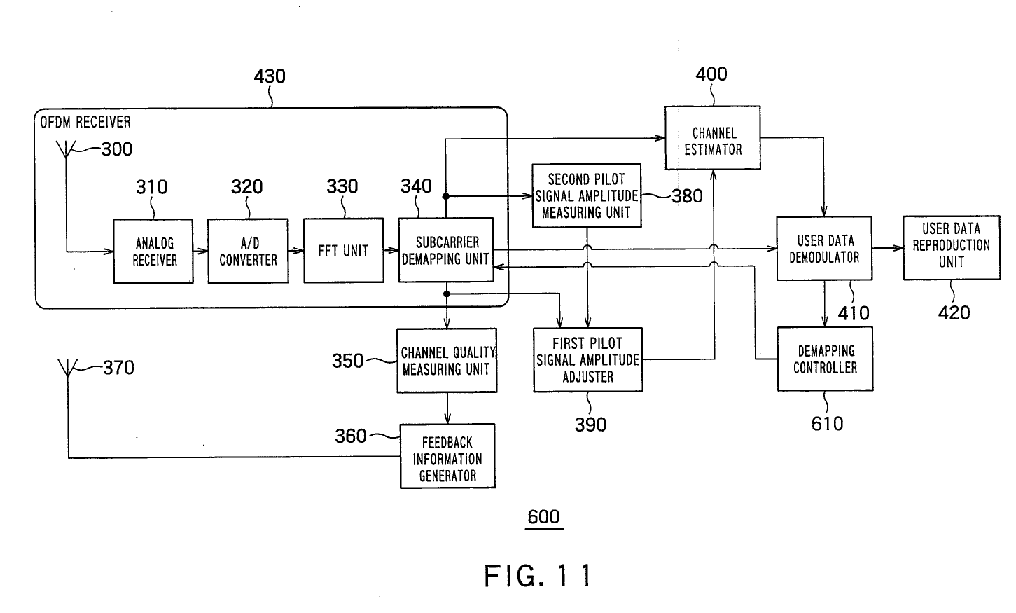

FIG. 11 illustrates the configuration of a terminal 600 according to the second embodiment. Compared to FIG. 8 which shows the configuration of the terminal 30 in the first embodiment, this is one with a demapping controller 610 added. Furthermore, the demapping controller 610 is connected to a user data demodulator 410 and a subcarrier demapping unit 340.

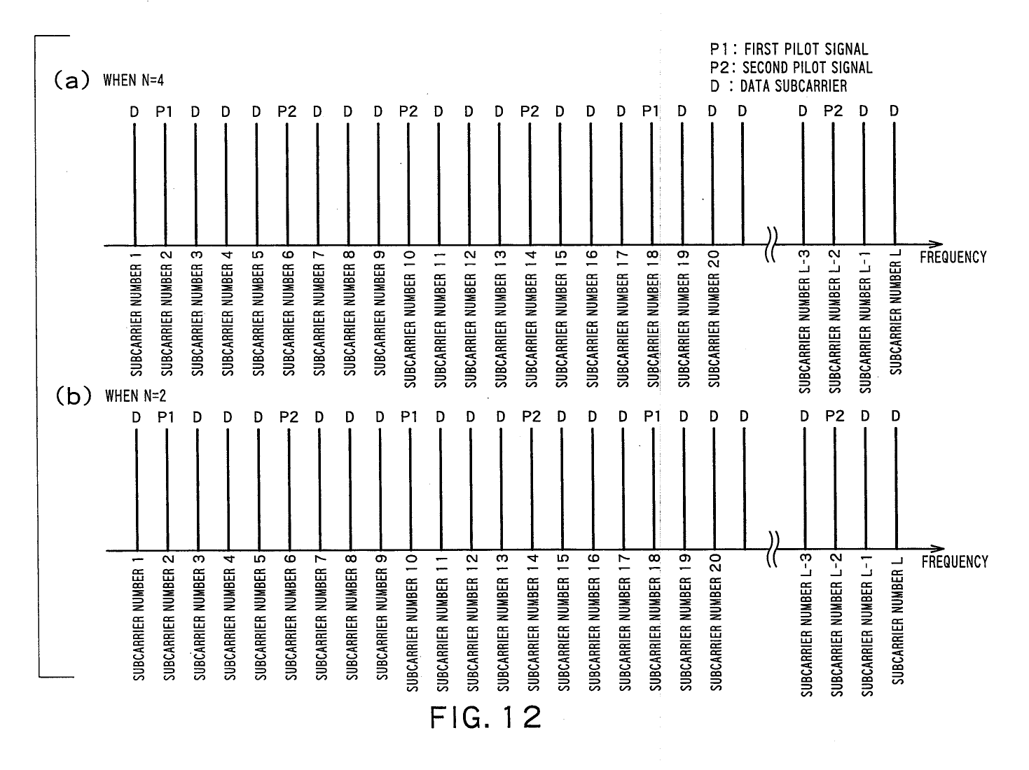

When the terminal 600 receives a signal, the value of N in the signal is unknown. However, since there is an arrangement that N is equal to or more than 2 and a power of 2, there are always subcarriers to which second pilot signals are mapped. For example, FIG. 12 shows subcarrier arrangements when M=4 and N=4 (FIG. 12(a)) and N=2 (FIG. 12(b)), and in both cases, second pilot signals are arranged on the sixth subcarrier and the fourteenth subcarrier. In the same way, no matter what N within the arrangement may be, subcarriers on which second pilot signals are arranged can be obtained. The number of this subcarrier is given by (2k+1)M+M_{b}(k=0, 1, 2, . . . (L−M_{b}−2M)/2M). Therefore, the subcarrier demapping unit 340 always extracts second pilot signals only from subcarriers to which second pilot signals are mapped first. Furthermore, when the value of N is revealed later, all first pilot signals, second pilot signals and user data are extracted as in the case of the first embodiment.

A channel estimator 400 determines a temporary channel estimated value using some of the second pilot signals sent from the subcarrier demapping unit 340 when N is unknown. Though accuracy is low because only some of the second pilot signals are obtained, a channel estimated value can be obtained. Furthermore, when all second pilot signals are obtained later, the channel estimated value can be updated using the second pilot signals as in the case of the first embodiment.

The user data demodulator 410 demodulates a control signal obtained from the subcarrier demapping unit 340 using the temporary channel estimated value obtained from the channel estimator 400 when N is unknown. Since an error rate of a control signal is generally preferred to be suppressed to a small value, the control signal is sent using a highly error resistant method. For example, an error correction function is provided by adopting a QPSK signal which can be transmitted/received even in a relatively high noise environment or adding a redundant signal. Therefore, even a temporary channel estimated value with low accuracy can be demodulated. As the demodulating result, M and N described in the control signal are obtained and these are sent to the demapping controller 610. After the channel estimated value is determined using all second pilot signals later, all user data are demodulated using these second pilot signals as in the case of the first embodiment.

The demapping controller 610 indicates subcarrier numbers of first pilot signals and second pilot signals to be extracted by the subcarrier demapping unit 340 using the values of N output from the user data demodulator 410 and L and M known in the system. These subcarrier numbers are given using N according to the expression shown in the first embodiment.

In the operation of a feedback information generator 360, suppose that a second pilot signal request for requesting an increment/decrement of a second pilot signal is also generated and added to feedback information in addition to the first embodiment. When many errors occur during reception or when noise often occurs in second pilot signals and it is judged that sufficient channel estimation performance cannot be obtained, the feedback information generator 360 judges that there are not enough second pilot signals for demodulation and requests an increase as a second pilot signal request. On the contrary, when errors are too few or a certain level of degradation of the channel estimated value is permissible, the feedback information generator 360 requests a decrease as a second pilot signal request.

Operations of other blocks are the same as those in the first embodiment.

### (Control by Base Station)

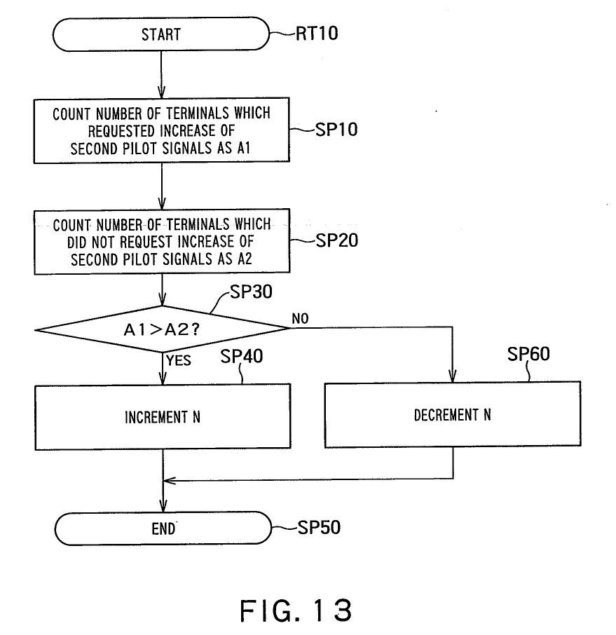

FIG. 13 is a flow chart showing a pilot signal control processing procedure RT10 of the pilot signal controller 510 at the base station 500. The pilot signal controller 510 receives a second pilot signal request sent from each terminal 600 from the feedback information receiver 240 as input.

In step SP10, the pilot signal controller 510 calculates the number of terminals A1 which requested an increase of second pilot signals first. In step SP20, at the same time, the pilot signal controller 510 measures the number of the terminals A2 which did not request any increase of second pilot signals.

When A1 is large, this means that there are many terminals 600 that consider the amount of second pilot signals for demodulation is not enough, and therefore the amount of first pilot signals should be decreased and the amount of second pilot signals should be increased to improve the accuracy of the channel estimated value. Therefore, in step SP30, when A1>A2, the flow moves to step SP40 and increments N. In the step of incrementing N, N may be doubled as in FIG. 13 or if a power of 2 is multiplied, a different amount of increase may also be used. On the contrary, when A1>A2 does not hold in step SP30, the flow moves to step SP60 and N is reduced to half. However, N should never fall to or below 2. N need not be reduced to half and if N is divided by a power of 2, a different amount of decrease may also be used.

In FIG. 13, N is always changed every time processing is performed, but N need not always be updated every time and it is also possible to perform this processing when the difference between A1 and A2 is equal to or above a threshold A.

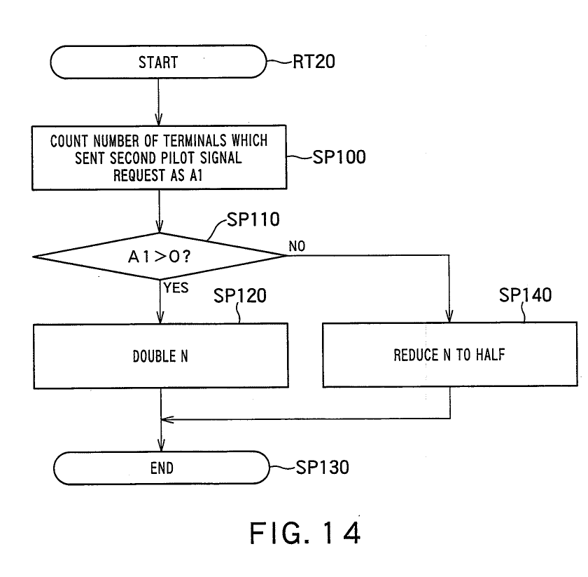

It is also possible to use a pilot signal control processing procedure RT20 shown in FIG. 14 as another method. According to this processing procedure RT20, control is performed in such a way that in step SP100, only A1 is calculated, and if A1>0 in step 110, that is, when even one terminal requests an increase as the second pilot signal request, the flow moves to step SP120 and doubles N and if A1=0 in step SP110, the flow moves to step SP140 and reduces N to half. In this case, the constant in the decision part may be set to A instead of 0 as in the case of the above described example. Furthermore, when N is incremented/decremented, it is also possible to adopt a different value for a multiple or divisor under the constraint that N is equal to or greater than 2 and a power of 2.

### (Effects)

The number of second pilots can be controlled using the above described method. The system requires that the channel estimated value determined from second pilot signals have higher accuracy than the channel quality measurement value determined from first pilot signals. Therefore, as in the case of this embodiment, it is possible to realize channel estimation with high accuracy and also realize channel quality measurement by securing necessary and sufficient second pilot signals according to a request from the terminal 600. It is possible to determine the number of necessary second pilot signals according to the reception condition of the terminal 600.

In this way, controlling the density of pilot signals for channel estimation based on the feedback from the terminal can prevent demodulation performance from degrading. Because of this, though the density of pilot signals for channel quality measurement changes, it is all right even when accuracy of pilots for channel quality measurement deteriorates to a certain degree, and therefore control is performed with higher priority given to pilots for channel estimation.

This embodiment extracts second pilot signals only from subcarriers to which second pilot signals are mapped to demodulate a control signal and determines a temporary channel estimated value. However, when, for example, a control signal is sent with phase modulation such as BPSK and QPSK, the amplitude reference is not always necessary for demodulation. Therefore, it is also possible to determine only a phase reference from both pilot signals and perform demodulation irrespective of whether pilots are first pilots or second pilots.

### (3) Third Embodiment

### Overview

Next, a third embodiment will be explained. The third embodiment presupposes a radio communication system made up of a base station and a terminal using MIMO (Multi-Input Multi-Output) transmission. During MIMO transmission, different user data are transmitted from a plurality of antennas on the transmitting side. On the receiving side, a mixture of both signals is received, but it is known that if the signals are received also using a plurality of antennas on the receiving side, the signals can be separated through processing such as MLD (Maximum Likelihood Detection).

However, channel estimation between the respective antennas is essential in order for the receiving side to separate the signals. Therefore, in order to estimate channels from a plurality of transmission antennas of the base station to a plurality of reception antennas, it is necessary to send known signals, that is, second pilot signals from the respective transmission antennas. On the other hand, to measure channel quality, first pilot signals must be transmitted, too. When both first pilot signals and second pilot signals are sent from all antennas of the base station, the amount of user data that can be sent decreases correspondingly, leading to a reduction of throughput.

Therefore, focusing attention on the fact that channel quality measurement using first pilot signals can have relatively lower accuracy than channel estimation and that average propagation loss in the entire transmission/reception band does not constitute a significant difference between the antennas, this embodiment considers transmitting first pilots and second pilots from different antennas of the base station. The number of transmission antennas of the base station and the number of reception antennas of the terminal can be arbitrarily selected, but suppose there are two antennas on each side.

### (Configuration of Base Station)

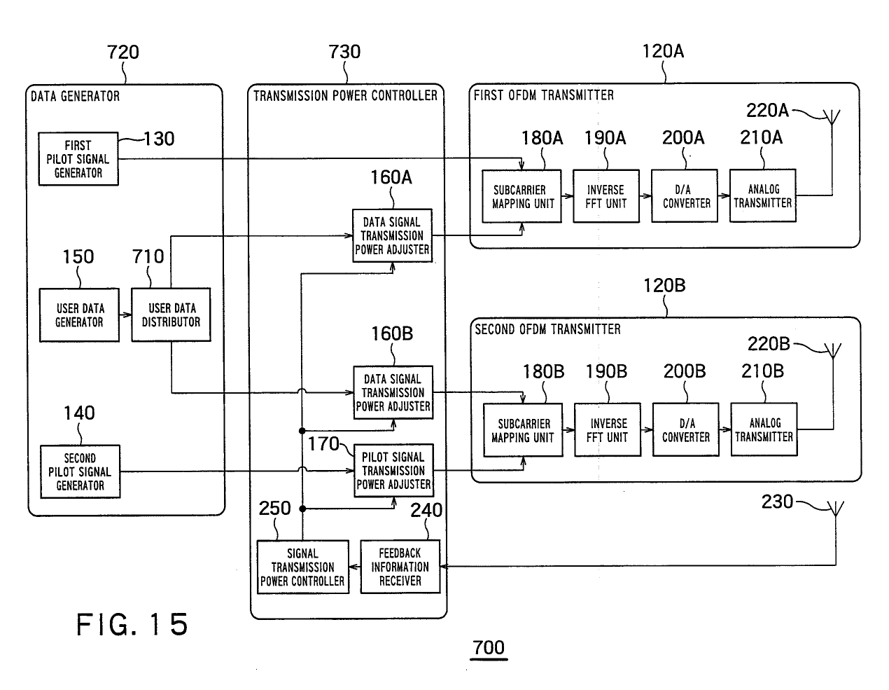

FIG. 15 describes the configuration of a base station 700 according to this embodiment. Differences from the configuration diagram of the base station 20 according to the first embodiment shown in FIG. 6 include that the data signal transmission power adjuster 160 has been adapted to be made up of two systems; data signal transmission power adjusters 160A and 160B to be adaptable to MIMO transmission, that the OFDM transmitter 120 also has been adapted to be made up of two systems; a first OFDM transmitter 120A and a second OFDM transmitter 120B and that a user data distributor 710 has been added to distribute user data to these two systems. The functions from the data signal transmission power adjusters 160A and 160B to base station transmission antennas 220A and 220B are the same as those in the first embodiment.

Furthermore, the first OFDM transmitter 120A receives first pilot signals not subjected to transmission power control as input and the second OFDM transmitter 120B receives second pilot signals subjected to transmission power control as input. Suppose signal transmission power control signals inputted to the two data signal transmission power adjusters 160A and 160B and those inputted to a pilot signal transmission power adjuster 170 which acts on second pilot signals are identical signals. That is, all these signals are likewise subjected to transmission power control.

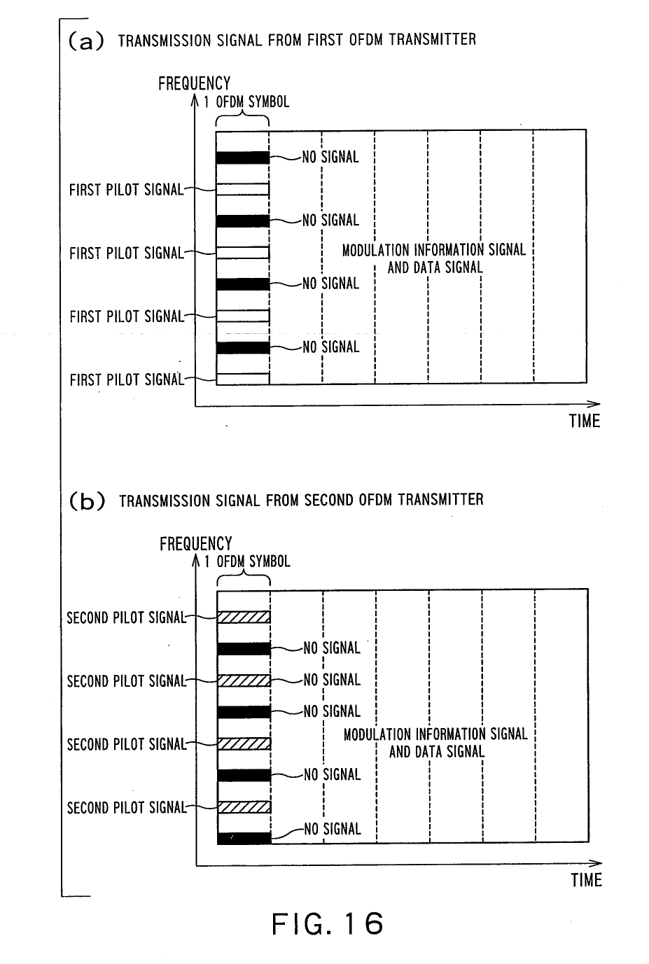

FIG. 16 shows mapping examples at subcarrier mapping units 180A and 180B. Suppose first pilot subcarriers and second pilot subcarriers are mapped to different subcarriers. Furthermore, to avoid interference with first pilot subcarriers transmitted from the first OFDM signal transmitter 120A, suppose identical subcarriers transmitted from the second OFDM transmitter 120B are in a no-signal state. Likewise, to avoid interference with second pilot subcarriers transmitted from the second OFDM signal transmitter 120B, suppose identical subcarriers transmitted from the first OFDM transmitter 120A are in a no-signal state. That is, according to this embodiment, the subcarrier mapping unit of the first OFDM transmitter 120A maps first pilot signals to subcarriers with numbers expressed by

Mk+M_{b1}(k=1, 2, . . . (L−M_{b1})/M) [Equation 7]

At the same time, suppose subcarriers with numbers expressed by

Mk+M_{b2}(k=1, 2, . . . (L−M_{b2})/M) [Equation 8]

are in a no-signal state. Likewise, the subcarrier mapping unit of the second OFDM transmitter 120B maps second pilot signals to subcarriers with numbers expressed by

Mk+M_{b2}(k=1, 2, . . . (L−M_{b2})/M) [Equation 9]

At the same time, suppose subcarriers with numbers expressed by

Mk+M_{b1}(k=1, 2, . . . (L−M_{b1})/M) [Equation 10]

are in a no-signal state. Suppose M_{b1} and M_{b2} have different values.

According to the above described configuration, only pilot signals transmitted from the first OFDM transmitter 120A are first pilot signals transmitted with constant power. Furthermore, user data transmitted from the first OFDM transmitter 120A and pilot signals and user data transmitted from the second OFDM transmitter 120B are likewise subjected to transmission power control.

The terminal then extracts first pilot signals transmitted from the first OFDM transmitter 120A and can thereby obtain channel quality such as propagation loss. The terminal can also demodulate the user data transmitted from the second OFDM transmitter 120B using second pilot signals extracted from the second OFDM transmitter 120B.

Furthermore, as shown in the first embodiment, first pilot signal power is adjusted so that the average signal amplitude of the second pilot signals matches the average signal amplitude of the first pilot signals and a corrected first pilot signal is obtained. The amount of correction in this power adjustment is substantially equal to that corresponding to the transmission power change multiplied at the data signal transmission power adjusters 160A and 160B on the base station 700 side. That is, this is the power difference between the first pilot signal and the user data signal, and the amplitude of the corrected first pilot signal is substantially equal to the user data amplitude. Therefore, the corrected first pilot signal can be used to demodulate the user data transmitted from the first OFDM transmitter 120A.

### (Configuration of Terminal)

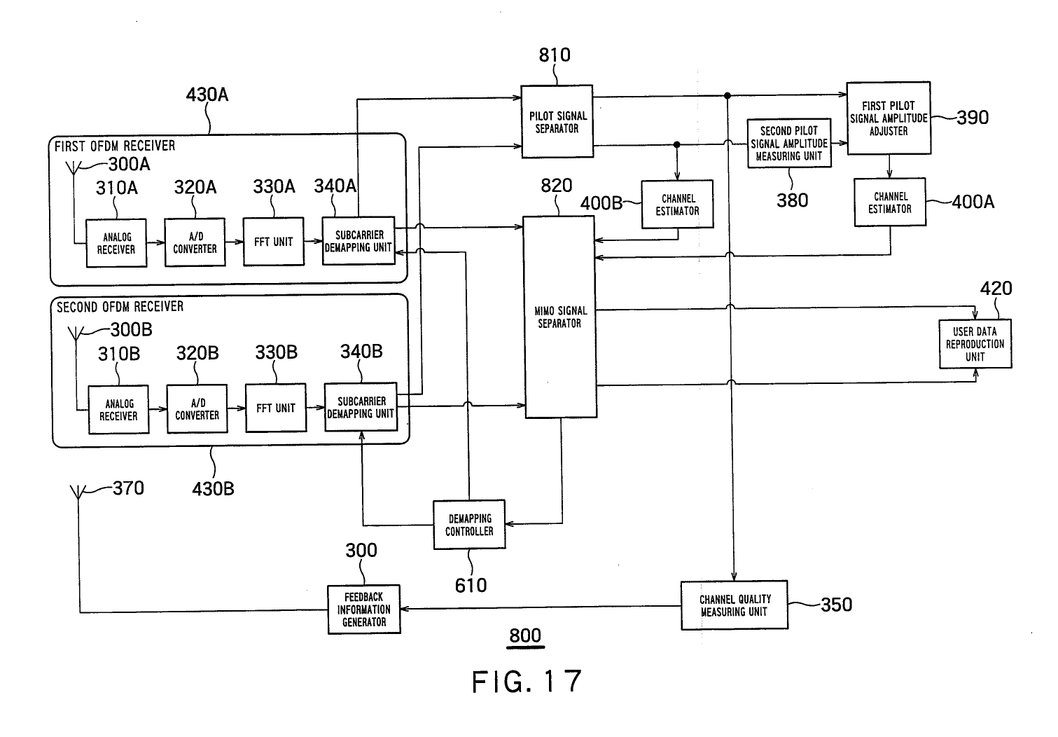

FIG. 17 shows the configuration of a terminal 800 according to this embodiment. Differences from the diagram showing the configuration of the terminal 30 in the first embodiment shown in FIG. 8 include the fact that the OFDM receiver 430 has been adapted to be made up of two systems; a first OFDM receiver 430A and a second OFDM receiver 430B to receive a MIMO signal, that a pilot signal separator 810 has been added to output first pilot signals and second pilot signals separately, that the channel estimator 400 has been adapted to be made up of two systems; channel estimators 400A and 400B, and that a MIMO signal separator 820 has been added.

The operations of the first OFDM receiver 430A and the second OFDM receiver 430B are the same as that of the OFDM receiver 430 in the first embodiment. Both systems receive control signals indicating from which subcarriers pilot signals and user data are extracted from a demapping controller 610 as input. Subcarrier demapping units 340A and 340B receive two signals as input; this control signal and each subcarrier signal obtained from FFT units 330A and 330B. There are also two outputs; one is an output for transmitting user data to the MIMO signal separator 820 and the other is a signal output of a pilot subcarrier with the number that matches any one of the following expressions received as a mixture of a first pilot signal and a second pilot signal.

Mk+M_{b1}(k=1, 2, . . . (L−M_{b1})/M)

Mk+M_{b2}(k=1, 2, . . . (L−M_{b2})/M) [Equation 11]

The pilot signal separator 810 extracts first pilot signals and second pilot signals from pilot signals inputted from two subcarrier demapping units 340A and 340B. A first pilot signal can be extracted from a subcarrier with the number expressed by

Mk+M_{b1}(k=1, 2, . . . (L−M_{b1})/M) [Equation 12]

and a second pilot signal can be extracted from a subcarrier with the number expressed by

Mk+M_{b2}(k=1, 2, . . . (L−M_{b2})/M) [Equation 13]

Of course, both first and second pilot signals can be obtained from both the first and second OFDM receivers 430A and 430B. Therefore, the pilot signal separator 810 has four outputs. That is, the first pilot signal and the second pilot signal received at the first OFDM receiver 430A, and the first pilot signal and the second pilot signal received at the second OFDM receiver 430B.

Of the four signals outputted from the pilot signal separator 810, two outputs related to the second pilot signal are inputted to a second pilot signal amplitude measuring unit 380. Signal amplitude is then measured as in the case of the first embodiment. For example, suppose average amplitude of all second pilot signals received at the two OFDM receivers 430A and 430B is calculated and outputted.

The value outputted from the second pilot signal amplitude measuring unit 380 is inputted to a first pilot signal amplitude adjuster 390. It is then adjusted so that the first pilot signal amplitude matches the second pilot signal amplitude as in the case of the first embodiment.

There are two channel estimators 400A and 400B for first pilot signals and second pilot signals but their functions are identical. The channel estimator 400A which receives a first pilot signal as input estimates the channel between the first OFDM transmitter 120A of the base station 700 and the first OFDM receiver 430A of the terminal 800 and the channel between the first OFDM transmitter 120A of the base station 700 and the second OFDM receiver 430B of the terminal 800.

In the same way, the channel estimator 400B which receives a second pilot signal as input estimates the channel between the second OFDM transmitter 120B of the base station 700 and the first OFDM receiver 430A of the terminal 800 and the channel between the second OFDM transmitter 120B of the base station 700 and the second OFDM receiver 430B of the terminal 800. The four channels estimated by the above described processing are sent to the MIMO signal separator 820.

The MIMO signal separator 820 extracts data signals sent from the first OFDM transmitter 120A and the second OFDM transmitter 120B of the base station 700. That is, the data signal inputted to the MIMO signal separator 820 is a mixture of the data signals sent from the first OFDM transmitter 120A and the second OFDM transmitter 120B through the radio channel and these signals are separated using the four channel estimated values sent from the channel estimators 400A and 400B and using a MIMO signal separation technique such as MLD. The separated signals are sent to a user data reproduction unit 420 to further reproduce the transmitted signal. The operation of the user data reproduction unit 420 is same as that in the first embodiment. Many of the MIMO signal separation techniques such as MLD are based on a scheme carrying out demodulation as well as signal separation, and therefore the user data demodulator is omitted from FIG. 17.

If there are signals related to demapping among control signals obtained from the MIMO signal separator 820, these signals are sent to a demapping controller 610. However, changes to L, M and N are not considered, the demapping controller 610 is not always necessary. If there are changes to L, M and N related to demapping, the demapping controller 610 sends control information to the subcarrier demapping units 340A and 340B.

First pilot signals outputted from the pilot signal separator 810 are inputted to a channel quality measuring unit 350. Channel quality of each subband, each transmission antenna are then measured using each pilot signal. The results are sent to a feedback information generator 300 and fed back to the base station 700 as in the case of the first embodiment.

### (Effects)

The conventional system needs to send both first pilot signals not subject to transmission power control and second pilot signals subject to transmission power control from a plurality of transmission antennas. However, this embodiment transmits first pilot signals from some transmission antennas and transmits second pilot signals from the remaining transmission antennas, and can thereby reduce the total amount of pilots to be transmitted. Correspondingly, more user data can be transmitted and the throughput is thereby improved.

In this way, when MIMO is used, pilot signals are transmitted from two antennas, but it would be redundant to transmit both pilots for channel quality measurement and pilots for channel estimation from both antennas. Therefore, pilot signals for channel quality measurement not subject to transmission power control are transmitted from one antenna and pilot signals for channel estimation are transmitted from the other antenna. The receiver can know the amount of transmission power control by measuring the power difference between the pilot signals. Using this value, it is possible to use pilot signals for channel quality measurement transmitted with fixed power as channel estimated values.

The above configuration can also be applied to a MISO (Multi-Input Single-Output) communication that uses a single antenna as a terminal reception antenna. The MISO communication is mainly used to improve channel quality and known as a transmission diversity technique.

1. A radio communication system in which a base station using a multicarrier transmission scheme as a transmission scheme and a terminal apparatus are wirelessly connected,
wherein the base station comprises:
a data generator configured to generate first pilot signals for the terminal apparatus to measure channel quality, second pilot signals for the terminal apparatus to estimate a channel and data signals to be transmitted to the terminal apparatus;
a transmission power controller configured to control transmission power of the second pilot signals and the data signals by adjusting amplitude of the second pilot signals and the data signals respectively; and
a transmitter configured to generate subcarrier data by mapping the first pilot signals, the second pilot signals power-controlled by the transmission power controller and the data signals power-controlled by the transmission power controller to a plurality of subcarriers and transmit the subcarrier data generated.

2. The system according to claim 1, wherein the transmitter maps at least one of the second pilot signals to a subcarrier arranged between subcarriers to which the first pilot signals are mapped.

3. The system according to claim 1, wherein the terminal apparatus comprises:
a receiver configured to perform a Fourier transform on received signals obtained by an antenna and thereby acquire the first and second pilot signals and the data signals;
an amplitude measuring unit configured to measure the amplitude of the second pilot signals;
an amplitude adjuster configured to adjust the amplitude of the first pilot signals to same amplitude as that of the second pilot signals;
a channel estimator configured to estimate a channel using the first pilot signals whose amplitude is adjusted and the second pilot signals and thereby acquire a channel estimated value indicating a state of the channel; and
a demodulator configured to demodulate the data signals using the channel estimated value.

4. The system according to claim 3, wherein the terminal apparatus further comprises:
a channel quality measuring unit configured to measure reception power of the first pilot signals obtained by the receiver and thereby measure the channel quality; and
a feedback information generator configured to add information on the second pilot signals received by the receiver to information on the channel quality to thereby generate and transmit feedback information,
the base station further comprises a feedback information receiver configured to receive the feedback information from the terminal apparatus and extract information on the second pilot signals from the feedback information, and
the transmitter of the base station controls the number of the second pilot signals based on extracted information on the second pilot signals.

5. A radio communication system in which a base station using a multicarrier transmission scheme as a transmission scheme and a terminal apparatus each having a plurality of transmission antennas are wirelessly connected,
wherein the base station comprises:
a data generator configured to generate first pilot signals for the terminal apparatus to measure channel quality, second pilot signals for the terminal apparatus to estimate a channel and data signals to be transmitted to the terminal apparatus and divide the data signals into portions corresponding in number to the plurality of transmission antennas;
a transmission power controller configured to control transmission power of the second pilot signals and each divided data signals by adjusting the amplitude of the second pilot signals and each divided data signals respectively; and
a plurality of transmitters provided in correspondence with the respective transmission antennas configured to map the first or second pilot signals and the divided data signals to a plurality of subcarriers to generate subcarrier data in such a way that the first and second pilot signals are each transmitted from at least one of the transmission antennas and transmit generated subcarrier data from the respective transmission antennas.

6. A base station which is wirelessly connected to a terminal apparatus and uses a multicarrier transmission scheme as a transmission scheme, comprising:
a data generator configured to generate first pilot signals for the terminal apparatus to measure channel quality, second pilot signals for the terminal apparatus to estimate a channel and data signals to be transmitted to the terminal apparatus;
a transmission power controller configured to control transmission power of the second pilot signals and the data signals by adjusting amplitude of the second pilot signals and the data signals respectively; and
a transmitter configured to generate subcarrier data by mapping the first pilot signals, the second pilot signals power-controlled by the transmission power controller and the data signals power-controlled by the transmission power controller to a plurality of subcarriers and transmit the subcarrier data generated.

7. The base station according to claim 6, wherein the transmitter maps at least one of the second pilot signals to a subcarrier arranged between subcarriers to which the first pilot signals are mapped.

8. The base station according to claim 6, further comprising a feedback information receiver configured to receive feedback information including information on the second pilot signals from the terminal apparatus and extract the information on the second pilot signals from the feedback information,
wherein the transmitter controls the number of the second pilot signals based on extracted information on the second pilot signals.

9. A terminal apparatus wirelessly connected to a base station using a multicarrier transmission scheme as a transmission scheme, comprising:
a receiver configured to perform a Fourier transform on received signals obtained by an antenna and thereby acquire first pilot signals for measuring channel quality and second pilot signals for estimating a channel and data signals;
an amplitude measuring unit configured to measure amplitude of the second pilot signals;
an amplitude adjuster configured to adjust the amplitude of the first pilot signals to same amplitude as that of the second pilot signals;
a channel estimator configured to estimate a channel using the first pilot signals whose amplitude is adjusted and the second pilot signals and thereby acquire a channel estimated value indicating a state of the channel; and
a demodulator configured to demodulate the data signals using the channel estimated value.

10. The terminal apparatus according to claim 9, further comprising:
a channel quality measuring unit configured to measure reception power of the first pilot signals obtained by the receiver and thereby measure the channel quality; and
a feedback information generator configured to add information on the second pilot signals received by the receiver to information on the channel quality to thereby generate and transmit feedback information.

11. A base station having a plurality of transmission antennas which is wirelessly connected to a terminal apparatus and uses a multicarrier transmission scheme as a transmission scheme, comprising:
a data generator configured to generate first pilot signals for the terminal apparatus to measure channel quality, second pilot signals for the terminal apparatus to estimate a channel and data signals to be transmitted to the terminal apparatus and divide the data signals into portions corresponding in number to the plurality of transmission antennas;
a transmission power controller configured to control transmission power of the second pilot signals and each divided data signals by adjusting the amplitude of the second pilot signals and each divided data signals respectively; and
a plurality of transmitters provided in correspondence with the respective transmission antennas configured to map the first or second pilot signals and the divided data signals to a plurality of subcarriers to generate subcarrier data in such a way that the first and second pilot signals are each transmitted from at least one of the transmission antennas and transmit generated subcarrier data from the respective transmission antennas.

12. A pilot signal controlling method of a radio communication system in which a base station using a multicarrier transmission scheme as a transmission scheme and a terminal apparatus are wirelessly connected, comprising:
generating by the base station first pilot signals for the terminal apparatus to measure channel quality, second pilot signals for the terminal apparatus to estimate a channel and data signals to be transmitted to the terminal apparatus;
controlling by the base station transmission power of the second pilot signals and the data signals by adjusting amplitude of the second pilot signals and the data signals respectively; and
generating by the base station subcarrier data by mapping the first pilot signals, the second pilot signals power-controlled and the data signals power-controlled to a plurality of subcarriers and transmitting by the base station the subcarrier data generated.

13. The method according to claim 12, wherein the generating by the base station subcarrier data includes mapping at least one of the second pilot signals to a subcarrier arranged between subcarriers to which the first pilot signals are mapped.

14. The method according to claim 12, further comprising:
performing by the terminal apparatus a Fourier transform on received signals obtained by an antenna and thereby acquiring first pilot signals for measuring channel quality and second pilot signals for estimating a channel and data signals;
measuring by the terminal apparatus amplitude of the second pilot signals;
adjusting by the terminal apparatus adjust the amplitude of the first pilot signals to same amplitude as that of the second pilot signals;
estimating by the terminal apparatus a channel using the first pilot signals whose amplitude is adjusted and the second pilot signals and thereby acquire a channel estimated value indicating a state of the channel; and
demodulating by the terminal apparatus the data signals using the channel estimated value.

15. The method according to claim 14, further comprising:
measuring by the terminal apparatus reception power of the first pilot signals and thereby measuring the channel quality;
adding by the terminal apparatus information on the second pilot signals to information on the channel quality to thereby generate and transmit feedback information; and
receiving by the base station the feedback information from the terminal apparatus and extracting the information on the second pilot signals from the feedback information,
wherein the generating by the base station subcarrier data includes controls the number of the second pilot signals based on extracted information on the second pilot signals.
